(19) United States
(12) Patent Application Publication
(10) Pub. No.: US 2022/0276640 A1
(43) Pub. Date: Sep. 1, 2022

(54) LINE PRODUCTION FACILITY

(71) Applicant: FUJI CORPORATION, Chiryu (JP)

(72) Inventor: Shinya KUMAZAKI, Toyota-shi (JP)

(73) Assignee: FUJI CORPORATION, Chiryu (JP)

(21) Appl. No.: 17/635,345

(22) PCT Filed: Sep. 10, 2019
(86) PCT No.: PCT/JP2019/035543

§ 371 Date: Feb. 14, 2022

(51) Int. Cl. G05B 19/418; H04L 67/12

(52) U.S. Cl. CPC G05B 19/4185; G05B 19/41865; H04L 67/12

(57) ABSTRACT

A linear production device that mechanically processes workpieces, the linear production device including: multiple modules arranged in a linear formation, wherein each of the modules is equipped with a control device to control the module and an operation panel that is connected to the control device to enable a worker to enter operations, each of the control devices has a preassigned ID number and is configured to communicate with the other control devices through a network, and an origin control device, which is a control device connected in a manner allowing communication to the operation panel that is currently being used by the operator, uses the ID number of the origin control device so as to use the origin control device as an origin to search for the ID numbers of the remaining control devices in the network to determine a line configuration of the linear production device.

### TECHNICAL FIELD

This specification relates to a linear production device.

### BACKGROUND ART

Patent Reference 1 discloses a form of linear production device comprising multiple industrial robots (hereinafter referred to as robots), multiple robot control devices (RCs) which are each connected to and control a single robot, a server computer (SC), and a programmable control device (PC). This production device is also provided with Network 1 (an information network), which connects the server computer with the multiple robot control devices, and Network 2 (a control network), which connects the programmable control device with the multiple robot control devices.

In this production system, each of the multiple robot control devices controlling one of the multiple robots is connected to Network 1 and Network 2 by first manually configuring communication between each robot control device and Network 1 with settings that include an address required to configure communication with Network 1. Next, an address range on Network 1 is assigned to one of the multiple robot control devices that will be configured to communicate with Network 2. Then, communication with Network 2 is set up by going through Network 1 from any other robot control device to configure the robot control device earlier linked with a Network 1 address range with the settings needed to establish communication with Network 2.

In more specific terms, all robot control devices linked to the address range specified on the second page of the Configuration screen go through the information network, Network 1, to launch certain processing operations in their own operating programs which self-set their addresses on the control network, Network 2, following the address allocation rules specified on the second page. In other words, once communication with Network 1 is set up, all other robot control devices can be configured to communicate with Network 2 by going through Network 1 from any of the robot control devices to be so configured.

### CITATION LIST

### Patent References

Patent Reference 1: JP-A-2006-270359

### BRIEF SUMMARY

### Technical Problem

Using the linear production device described in Patent Reference 1 facilitates the operation of setting up network communication when connecting multiple robot control devices to multiple networks. There is also a need for data stored in multiple control devices (robot control devices) in a single network to be easily manageable from one of the control devices.

A linear production device disclosed in this specification meets this need by enabling an operator to easily manage data stored in multiple control devices in a single network from one of the control devices.

### Solution to Problem

This specification discloses a linear production device that mechanically processes workpieces, the linear production device including: multiple modules arranged in a linear formation, wherein each of the modules is equipped with a control device to control the module and an operation panel that is connected to the control device to enable a worker to enter operations, each of the control devices has a preassigned ID number and is configured to communicate with the other control devices through a network, and an origin control device, which is the control device connected in a manner allowing communication to the operation panel that is currently being used by the operator, uses the ID number of the origin control device so as to use the origin control device as an origin to search for the ID numbers of the remaining control devices in the network to determine a line configuration of the linear production device.

### Advantageous Effects

This disclosure describes a linear production device in which each of the control devices provided for the multiple modules of the linear production device has a preassigned ID number and can also communicate with other control devices in the network. A line configuration of the modules in the linear production device is determined by connecting an operation panel that is currently being used by the operator to one of the multiple control devices, which is an origin control device, and using the ID number of the origin control device as an origin from which to search for other control devices in the network. The control device being used as an origin can use the connected operation panel to display the determined line configuration, and can reference the line configuration to display operation keys for copying data stored in each module. This allows data stored in multiple control devices in a network to be easily managed from one of the control devices (the origin control device).

### BRIEF DESCRIPTION OF DRAWINGS

FIG. 1

This is a front view showing the first embodiment, which is a processing system 10 that uses the linear production device.

FIG. 2

This is a side view showing the lathe module 30A shown in FIG. 1.

FIG. 3

This is a block diagram showing lathe module 30A.

FIG. 4

This is a front view showing the input-output device.

FIG. 5

This is an illustration showing the Data Management screen.

FIG. 6

This is a side view showing the drilling and milling module 30B shown in FIG. 1.

FIG. 7

This is a block diagram showing drilling and milling module 30B.

FIG. 8

This is a side view showing the pre-processing stock module 30C shown in FIG. 1.

FIG. 9

This is a side view showing articulated robot 70.

FIG. 10

This is a plan view showing articulated robot 70.

FIG. 11

This is a block diagram showing base module 20.

FIG. 12

This is a schematic diagram showing network 91.

FIG. 13

This is a flowchart showing the program performed by the control device SC shown in FIG. 12.

FIG. 14

This is a flowchart showing the program performed by the control device SC of the second embodiment, which is a processing system 10 that uses the linear production device.

FIG. 15

This is a schematic diagram showing the third embodiment, which is a processing system 10 that uses the linear production device.

FIG. 16

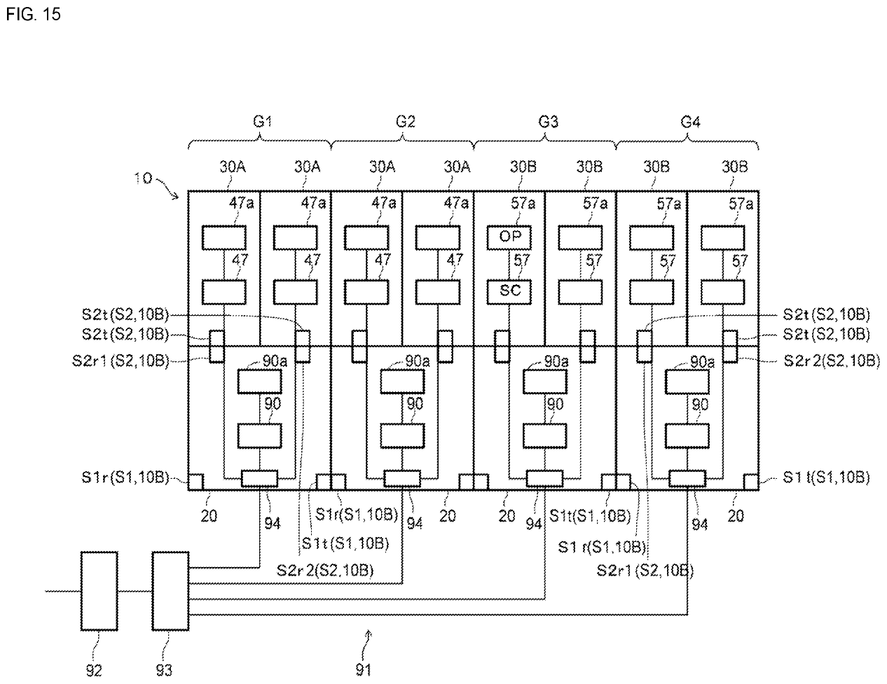

This is a flowchart showing the program performed by the control device SC shown in FIG. 15.

### DESCRIPTION OF EMBODIMENTS

### First embodiment

Processing System

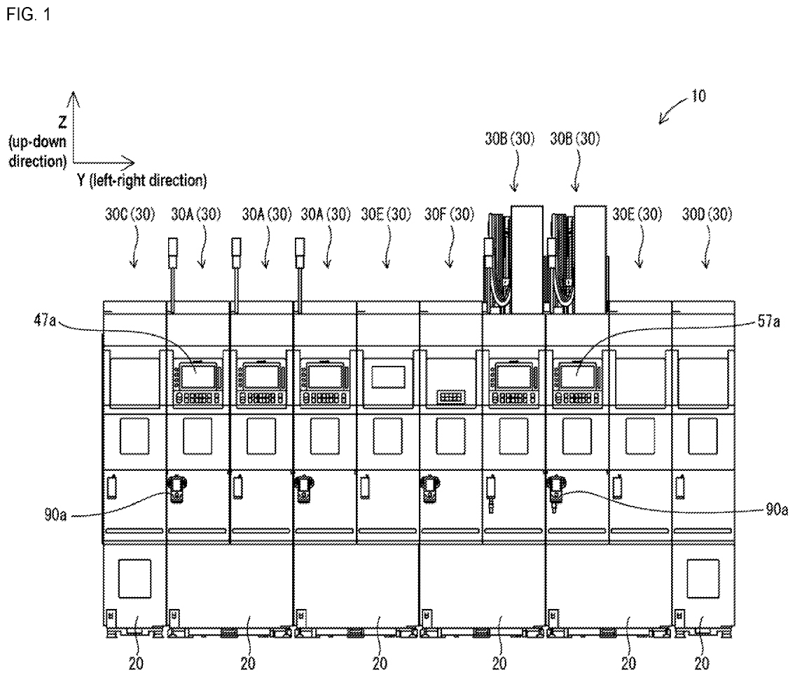

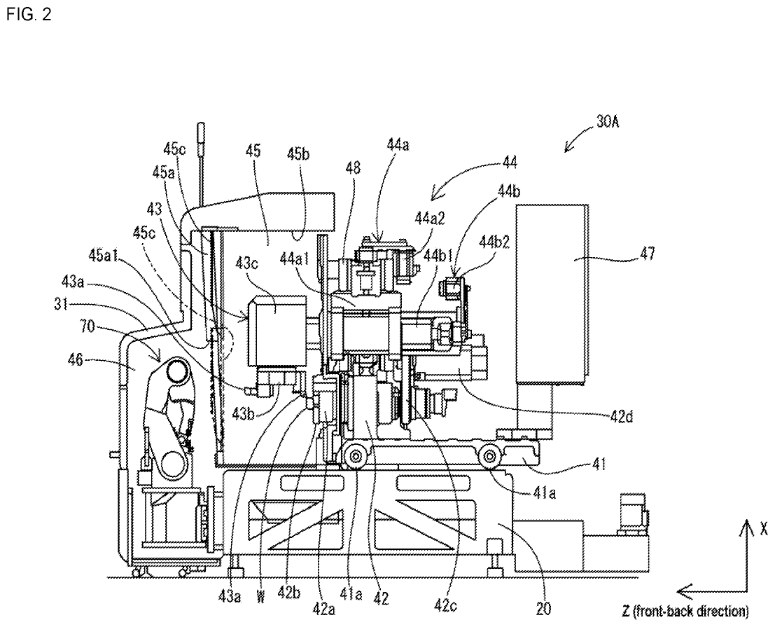

The first embodiment, which is an example of a processing system that uses the linear production device, is described below. As shown in FIG. 1, processing system (linear production device) 10 is provided with multiple base modules 20, multiple work machine modules 30 (ten in this embodiment) installed in the base modules 20, and an articulated robot 70 (hereinafter sometimes referred to as “robot”) (see FIG. 2 for an example). Processing system 10 is made up of multiple modules (including base modules 20 and work machine modules 30), arranged in a linear formation, that process a workpiece W. In the following description, when front-back, left-right, and up-down are mentioned with reference to processing system 10, these terms refer to front and back, left and right, and up and down when viewing processing system 10 from the front.

Base module 20 is provided with robot 70, which is a workpiece conveying device to be described later, and robot control device 90, which controls robot 70.

There are several types of work machine module 30, including lathe module 30A, drilling and milling module 30B, pre-processing stock module 30C, post-processing stock module 30D, inspection module 30E, and temporary storage module 30F.

Lathe Module

Lathe module 30A is a modularized lathe. The lathe is a machine tool that rotates workpiece W, which is the processing target object, and processes workpiece W using fixed cutting tool 43a. As shown in FIG. 2, lathe module 30A is provided with movable bed 41, headstock 42, tool rest 43, tool rest moving device 44, processing chamber 45, traveling chamber 46, and module control device 47 (hereinafter sometimes referred to as control device 47).

Movable bed 41 moves in the front-rear direction on rails (not shown) provided in base module 20 via multiple wheels 41a. Headstock 42 holds workpiece W to enable its rotation. Headstock 42 holds spindles 42a, which are arranged in a horizontal line in the front-rear direction, and enables their rotation. Chuck 42b is provided on the end of spindle 42a to grip workpiece W. Spindle 42a is rotated by servomotor 42d via rotation transmission mechanism 42c.

Tool rest 43 is a device that imparts a feeding motion to cutting tool 43a. Tool rest 43 is a so-called turret-type tool rest, and consists of tool holding section 43b, to which multiple cutting tools 43a to cut workpiece W are mounted, and rotatable rotation drive section 43c, which holds tool holding section 43b to enable it to rotate as well as supports it in a given cutting position.

Tool rest moving device 44 is a device that moves tool rest 43, and thus cutting tool 43a, in the up-down direction (X-axis direction) and front-rear direction (Z-axis direction). Tool rest moving device 44 is provided with X-axis drive device 44a, which moves tool rest 43 in the X-axis direction, and Z-axis drive device 44b, which moves tool rest 43 in the Z-axis direction.

X-axis drive section 44a is provided with X-axis slider 44a1, which is mounted in such a way that it can slide in the up-down direction with respect to column 48, which is attached to movable bed 41, and is provided with servomotor 44a2, which moves X-axis slider 44a1. Z-axis drive device 44b is provided with Z-axis slider 44b1, which is mounted in such a way that it can slide in the front-rear direction with respect to X-axis slider 44a1, and is provided with servomotor 44b2, which moves Z-axis slider 44b1.

Processing chamber 45 is a chamber (space) for processing workpiece W, and houses chuck 42b and tool rest 43 (cutting tool 43a, tool holding section 43b, and rotation drive section 43c). Processing chamber 45 is demarcated by front wall 45a, ceiling wall 45b, left and right walls, and a rear wall (none of which are shown). Entry-exit 45a1 is formed in front wall 45a, and is used to load and unload workpiece W. Entry-exit 45a1 is opened and closed by means of shutter 45c, which is driven by a motor which is not shown. The solid line indicates shutter 45c in an open state (open position) and the dot-dash line indicates shutter 45c in a closed state (closed position).

Traveling chamber 46 is a chamber (space) that faces entry-exit 45a1 of processing chamber 45. Traveling chamber 46 is demarcated by front wall 45a and front surface panel 31. Robot 70, to be described later, is able to travel inside traveling chamber 46.

Module control device, input-output device, etc.

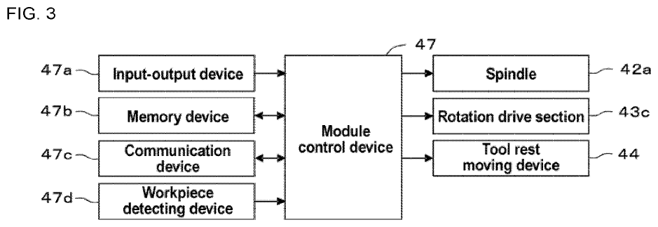

Module control device 47 is a control device that performs drive control of rotation drive section 43c, tool rest moving device 44, and related sections. As shown in FIG. 3, module control device 47 is connected to input-output device 47a, storage device 47b, communication device 47c, workpiece detecting device 47d, spindle 42a, rotation drive section 43c, and tool rest moving device 44. Module control device 47 is provided with a microcomputer (not shown), which is provided with an input-output interface, CPU, RAM, and ROM (none of which are shown) connected to each other via a bus. The CPU executes various programs to acquire data from input-output device 47a, storage device 47b, and communication device 47c, and controls input-output device 47a, spindle 42a, rotation drive section 43c, and tool rest moving device 44. The RAM is for temporarily storing the variables required to execute the program, and the ROM is for storing the program.

As shown in FIG. 1, input-output device 47a is provided on the front surface of work machine module 30, and is used by the operator to input settings and commands as well as to display information such as operating conditions and maintenance status. Input-output device 47a is a device enabling information to pass between humans and the machine, and is similar to an HMI (human machine interface) or man-machine interface. Input-output device 47a is an operation panel that workers can use to operate the device.

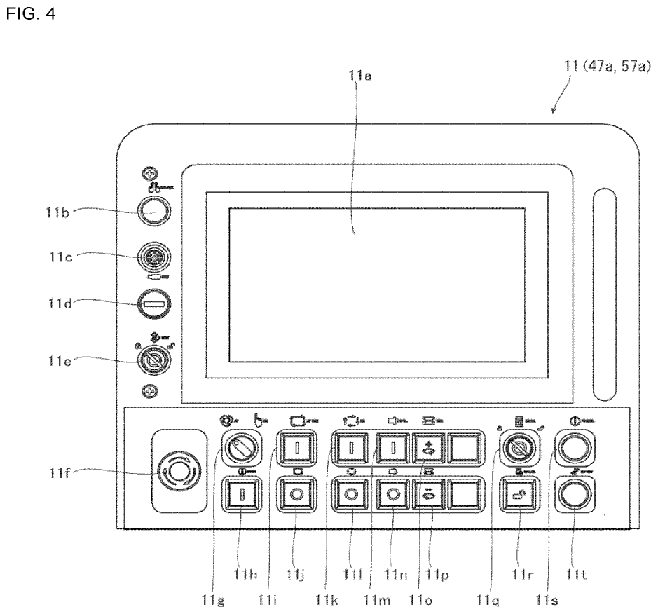

Input-output device 47a is shown as input-output device 11 in FIG. 4. Input-output device 11 is provided with display panel 11a, Manual Operation Auxiliary buttons 11b, alarm buzzer 11c, USB port 11d, Edit/No edit selector key 11e, Emergency Stop button 11f, Automatic/Manual selector switch 11g, Master ON button 11h, Automatic Start button 11i, Continuous OFF button 11j, NC Start button 11k, NC Pause button 11l, Spindle Start button 11m, Spindle Stop button 11n, Turret Forward Rotation button 11o, Turret Reverse Rotation button 11p, Door Interlock selector key 11q, Door Lock Release button 11r, Run button 11s, and Error Reset button 11t.

Display panel 11a is a touchscreen-type monitor that displays information. USB port 11d is a port into which USB can be inserted to import/export data. Edit/No Edit selector key 11e is used to edit programs, parameters, and other data that is stored in storage devices 47b, 57b, and 90b, or in storage devices inside control devices. When selector key 11e is positioned to the left, editing is disabled. When selector key 11e is positioned to the right, editing is enabled. The configuration of input-output device 57a of drilling and milling module 30B is substantially the same as the configuration of input-output device 47a of lathe module 30A, although the switches/buttons are slightly different.

Storage device 47b stores data related to control of lathe module 30A, such as control programs, parameters used in control programs, and data related to settings and commands. Communication device 47c is a device for communicating through the Internet with other modules in the same processing system, with different processing systems, and with computers performing integrated management of multiple processing systems.

Workpiece detecting device 47d is a device that detects whether workpiece W is attached to the tip of spindle 42a. Workpiece detecting device 47d detects whether workpiece W is present and notifies control device 47 of the detection result. Workpiece detecting device 47d can consist of such devices as a pressure sensor (contact sensor) or an imaging device.

Display Panel

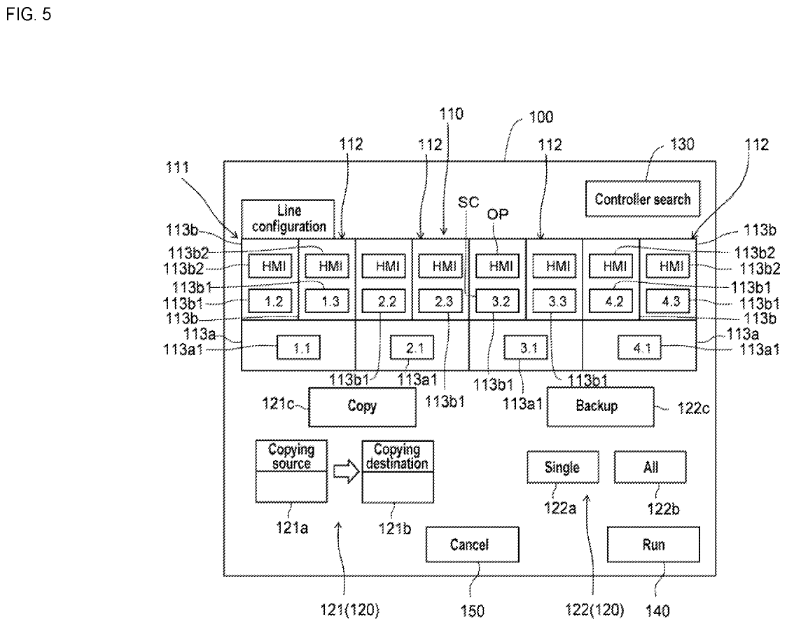

FIG. 5 shows Data Management screen 100 displayed in display panel 11a. Data Management screen 100 displays line configuration map 111, showing line configuration LC, which is derived by performing a search. Data Management screen 100 also shows operation keys 121c, 122c, 130, 140, and 150, which are used to copy data stored in the base modules 20 and work machine modules 30 shown in line configuration map 111. Data Management screen 100 is provided with line configuration display section 110, data copy operation section 120, Control Device Search key 130, Run key 140, and Cancel key 150. “Keys” are switches or pushbuttons.

Line configuration display section 110 displays line configuration map 111, which shows line configuration LC. Line configuration LC is the configuration of a line consisting of multiple groups G (in this embodiment, four groups (Group 1 [G1] to Group 4 [G4]) that are each composed of multiple base modules 20 and work machine modules 30.

Line configuration map 111 is a map composed of multiple group maps 112 representing groups G arranged in a left-right direction. Group map 112 is composed of three module maps 113. Three module maps 113 are composed from one base map 113a, which shows base modules 20, and two work machine maps 113b, which show work machine modules 30. Base map 113a is a horizontal rectangle, and two work machine maps 113b, which are vertical rectangles, are arranged on top of base map 113a. These base maps 113a and work machine maps 113b are integrated to form group maps 112, which are rectangular in shape.

Base map 113a shows address display section 113a1, which displays the IP address of control devices 90 of base modules 20. Work machine map 113b shows address display section 113b1, which displays the IP addresses of control devices 47 or 57 of work machine modules 30, along with input-output device map 113b2, which displays input-output devices 47a or 57a. The address display section 113a1 which displays the IP address of the origin control devices SC, should be distinguished from the other address display sections 113a1 by using a different background color or by a flashing display. The same is true of input-output device map 113b2, which displays the current operation panel.

Data copying operation section 120 is an operation section that copies data (data stored in control devices 47, 57, and 90, and in storage devices 47b, 57b, and 90b) contained in each module 20 and module 30. Data copying operation section 120 is provided with copying section 121, which copies data, and backup section 122, which backs up data. “Copying” means duplicating data stored in modules 20 and modules 30 and moving the data from a source to a destination. Destination and source can consist not only of storage devices 47b, 57b, and 90b that are built into modules, but also detachable memories (such as USB memory devices) connected to input-output devices 47a, 57a, and 90a. “Backup” means copying data stored in modules 20 or modules 30 to store as backup data, or saving the data in a restorable state. The backup destination can be a dedicated backup device connected to network 91, or a backup device connected to one of the control devices of network 91.

Copying section 121 is provided with copying source display section 121a, which displays the specified copying source, and copying destination display section 121b, which displays the specified copying destination, as well as Copy key 121c, which is used to select the desired copy function. Backup section 122 is provided with Single key 122a, which backs up single modules, All key 122b, which backs up all modules, and Backup key 122c, which selects the desired backup function.

Control Device Search key 130 is a selection key used to select (run) searches for control devices inside network 91. Run key 140 is a key that starts copy processes, backup processes, and search processes. Cancel key 150 is a key that cancels previously-selected origins and destinations as well as previously-selected copy processes, backup processes, and search processes.

Drilling and Milling Module

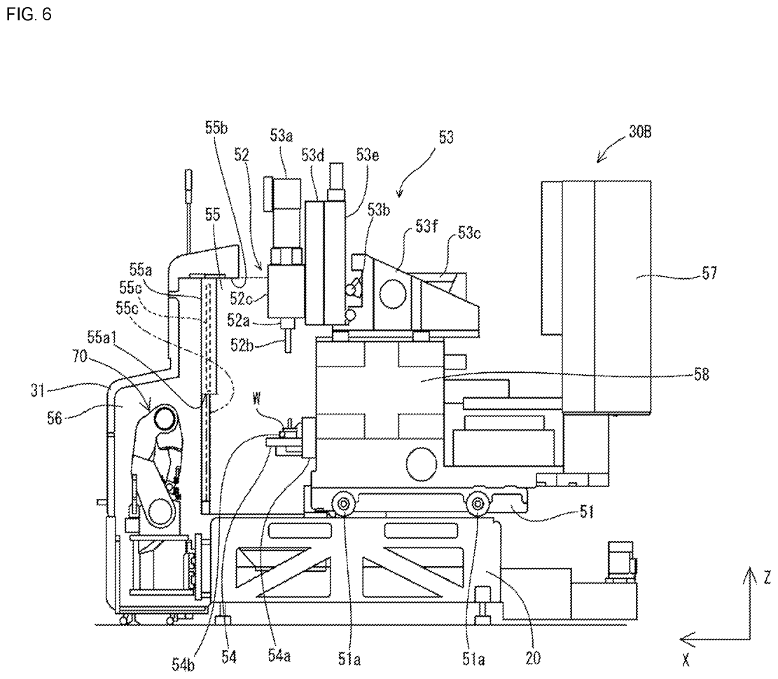

Drilling and milling module 30B is a modularized machining center that drills holes and performs milling processes. A machining center is a machine tool that processes workpiece W by pressing rotating tools against the workpiece while the workpiece is held in a fixed position. As shown in FIG. 6, drilling and milling module 30B is provided with movable bed 51, headstock 52, headstock moving device 53, workpiece table 54, processing chamber 55, traveling chamber 56, and module control device 57 (sometimes referred to as control device 57 in this specification).

Movable bed 51 moves in the front-rear direction on rails (not shown) provided in base module 20, using multiple wheels 51a. Headstock 52 holds spindle 52a in such a way that spindle 52a is able to rotate. Cutting tool 52b (which can consist of such elements as a drill or an end mill) can be mounted to the (lower) tip of spindle 52a to enable cutting of workpiece W. Spindle 52a is rotated by servomotor 52c.

Headstock moving device 53 is a device that moves headstock 52, thereby also moving cutting tool 52b, in the up-down direction (Z-axis direction), front-rear direction (X-axis direction), and left-right direction (Y-axis direction). Headstock moving device 53 is provided with Z-axis drive device 53a that moves headstock 52 in the Z-axis direction, X-axis drive device 53b that moves headstock 52 in the X-axis direction, and Y-axis drive device 53c that moves headstock 52 in the Y-axis direction. Z-axis drive device 53a moves headstock 52, which is attached in such a way that it can slide with respect to X-axis slider 53e, in the Z-axis direction. X-axis drive device 53b moves X-axis slider 53e, which is attached in such a way that it can slide with respect to Y-axis slider 53f, in the X-axis direction. Y-axis drive device 53c moves Y-axis slider 53f, which is attached in such a way that it can slide with respect to main body 58 provided on movable bed 51, in the Y-axis direction.

Workpiece table 54 holds workpiece W in a fixed position. Workpiece table 54 is secured to workpiece table rotating device 54a, which is provided on the front surface of main body 58. Workpiece table rotating device 54a is driven in a rotating motion around an axis line extending in the front-rear direction. This enables cutting tool 52b to process workpiece W as workpiece W is held at a given angle. Workpiece table 54 can also be fastened directly to the front surface of main body 58. Workpiece table 54 is provided with chuck 54b that grips workpiece W.

Processing chamber 55 is a chamber (space) for processing workpiece W, and stores headstock 52a, cutting tool 52b, workpiece table 54, and workpiece table rotating device 54a. Processing chamber 55 is demarcated by front wall 55a, ceiling wall 55b, left and right walls, and rear walls (none of which are shown). Entry-exit 55a1 is formed in front wall 55a, and is used to load and unload workpiece W. Entry-exit 55a1 is opened and closed by shutter 55c, which is driven by a motor which is not shown. The solid line indicates shutter 55c in an open state (open position) and the dot-dash line indicates shutter 55c in a closed state (closed position).

Traveling chamber 56 is a chamber (space) which faces entry-exit 55a1 of processing chamber 55. Traveling chamber 56 is demarcated by front wall 55a and front surface panel 31. Robot 70, which is described later, is able to travel inside traveling chamber 56. Adjacent traveling chamber 46 (or 56) forms a space that continues along the entire length of processing system 10 in the same direction that processing system 10 is laid out.

Module Control Device, Input-Output Device, Etc.

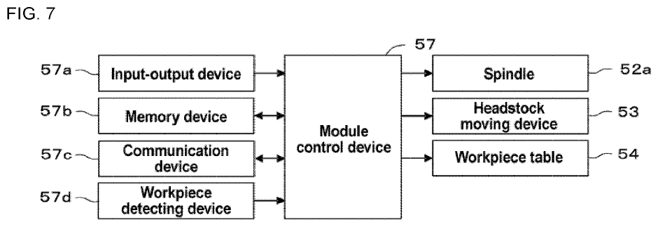

Module control device 57 is a control device that performs drive control of modules such as headstock 52a (servomotor 52c) and headstock moving device 53. As shown in FIG. 7, module control device 57 is connected to input-output device 57a, storage device 57b, communication device 57c, workpiece detecting device 57d, spindle 52a, headstock moving device 53, and workpiece table 54. Control device 57 is provided with a microcomputer (not shown), which is provided with an input-output interface, CPU, RAM, and ROM (none of which are shown) that are connected to one another via a bus.

As shown in FIG. 1, input-output device 57a is provided on the front surface of work machine module 30, and functions in the same way as input-output device 47a. Like input-output device 47a, input-output device 57a is shown as input-output device 11 in the figure. The Headstock Clamp button is used instead of Turret Rotation button 11o, and the Headstock Unclamp button is used instead of Turret Reverse Rotation button 11p. The other elements of this configuration are similar to those of input-output device 47a.

Storage device 57b stores data related to control of drilling and milling module 30B, such as control programs, parameters used in control programs, and data related to settings and commands. Communication device 57c is a device similar to communication device 47c.

Workpiece detecting device 57d is a device that detects whether workpiece W is attached to workpiece table 54. Workpiece detecting device 57d detects whether workpiece W is present and notifies control device 57 of the detection result. Workpiece detecting device 57d can consist of such devices as a pressure sensor (contact sensor) or an imaging device.

Stock Module, Measurement Module

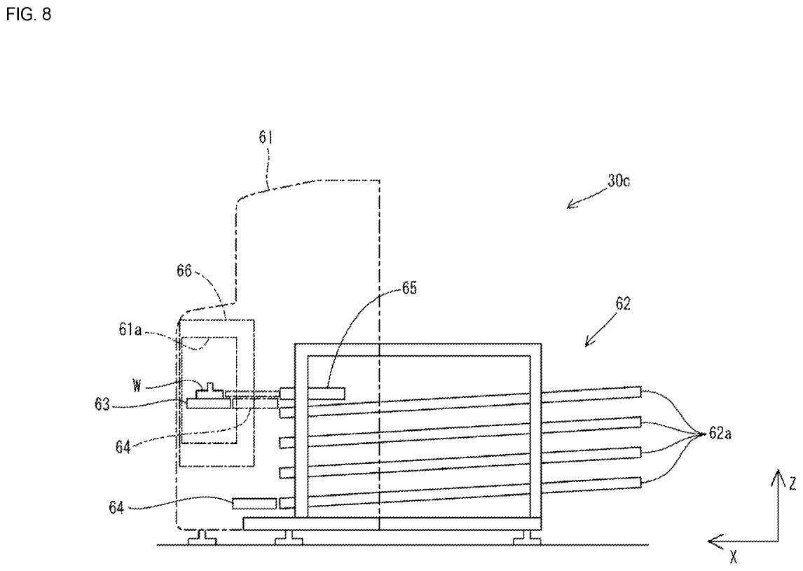

Pre-processing stock module 30C is a module (workpiece loading module, also sometimes referred to as loading module) that loads workpiece W into processing system 10. As shown in FIG. 8, pre-processing stock module 30C is provided with external panel 61, workpiece pool 62, loading table 63, lift 64, and cylinder device 65. External panel 61 is a panel that covers the front of pre-processing stock module 30C. Stock chamber 66 is provided inside external panel 61. Loading table 63 is housed in stock chamber 66. Stock chamber 66 is connected to traveling chambers 46 and 56 of adjacent work machine module 30 through entry-exit 61a, which is provided on the side surface of external panel 61.

Workpiece pool 62 is provided with multiple storage levels 62a (for example, four levels in this embodiment) that extend in the front-rear direction (X-axis direction). Storage level 62a is able to house multiple workpieces W. Loading table 63 is able to load workpiece W, and is provided on the front side of workpiece pool 62 in the front-rear direction. Loading table 63 is located at a position (the loading position) in which robot 70 is able to receive workpiece W.

Lift 64 is provided in front of workpiece pool 62. Lift 64 receives one workpiece W at a time from workpiece pool 62, and conveys workpiece W to the height of loading table 63. Cylinder device 65 is provided above the front of workpiece pool 62. Cylinder device 65 pushes workpieces W which are on top of lift 64 onto loading table 63.

Post-processing stock module 30D is a module (workpiece unloading module, also sometimes referred to as unloading module) that stores and unloads the finished workpiece after it has gone through the series of processes performed on workpiece W by processing system 10. Like loading table 63, post-processing stock module 30D is provided with a carry-out table or carry-out conveyor (neither of which are shown) which holds and carries out workpiece W. The carry-out table or carry-out conveyor is housed in a stock chamber (not shown) that is similar to stock chamber 66.

Measurement module 30E is a tool that measures workpiece W (for example, processed workpieces W). Temporary storage module 30F is provided as temporary storage for workpiece W while workpiece W is undergoing the series of processes performed by processing system 10. Like lathe module 30A and drilling and milling module 30B, measurement module 30E and temporary storage module 30F are provided with a traveling chamber (not shown).

Robot

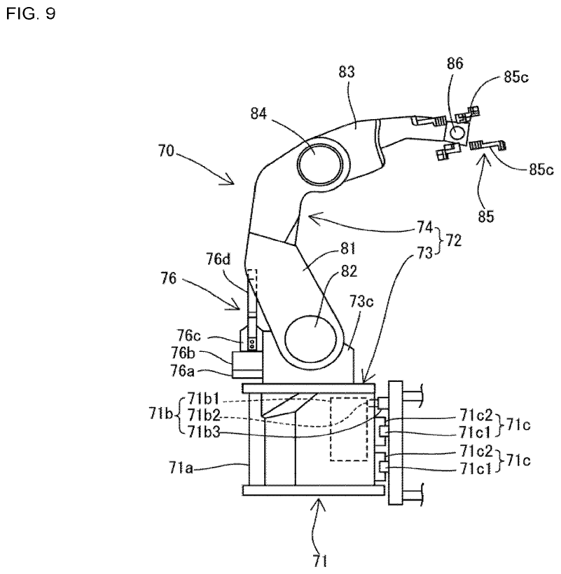

As shown in FIG. 9, robot 70 is able to travel, and is provided with traveling section 71 and main body section 72.

Traveling Section

Traveling section 71 is able to travel in the left-right direction (which is the Y-axis direction, and the direction in which work machine module 30 is laid out) inside traveling chambers 46 and 56. As shown in FIG. 9, traveling section 71 is primarily composed of traveling drive axis 71c, which is used by traveling drive device 71b to move traveling section main body 71a in a straight line in the left-right direction. (Traveling drive axis 71c is hereinafter sometimes referred to as the X-axis. This X-axis is the X-axis of the robot control system and is different from the X-axis direction of processing system 10.) Slider 71c2 of traveling drive axis 71c is attached to the back (rear) of traveling section main body 71a. Traveling drive axis 71c consists of rail 71c1 provided on the front side of base module 20, which extends in the horizontal direction (left-right direction) of base module 20, and multiple sliders 71c2 which engage with rail 71c1 in such a way that they enable sliding.

Traveling section main body 71a is provided with traveling drive device 71b. Traveling drive device 71b is composed of such elements as servomotor 71b1, a drive force transmission mechanism (not shown), pinion 71b2, and rack 71b3. The rotation of servomotor 71b1 is output to pinion 71b2, which thereby also rotates. Pinion 71b2 has gears which mesh with rack 71b3. Rack 71b3 is provided on the front side of base module 20, and extends in the horizontal direction (left-right direction) with respect to base module 20.

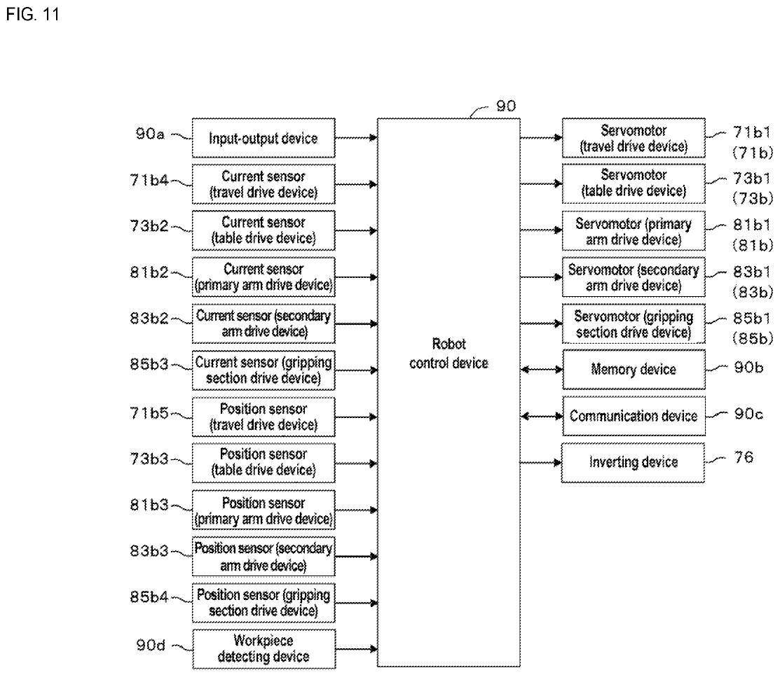

Servomotor 71b1 is connected to robot control device 90. (See FIG. 11. Robot control device 90 is hereinafter sometimes referred to as control device 90.) Servomotor 71b1 is driven in a rotating motion by commands from control device 90, causing pinion 71b2 to impart rolling motion to rack 71b3. This allows traveling section main body 71a to travel in the left-right direction inside traveling chambers 46 and 56. Servomotor 71b1 is equipped with current sensor 71b4, which detects the current flowing to servomotor 71b1 (see FIG. 11). Servomotor 71b1 is equipped with position sensor 71b5 (which can consist of a resolver or encoder), which detects the position (for example, rotation angle) of servomotor 71b1. (See FIG. 11.) The detection results of current sensor 71b4 and position sensor 71b5 are transmitted to control device 90.

Main Body Section

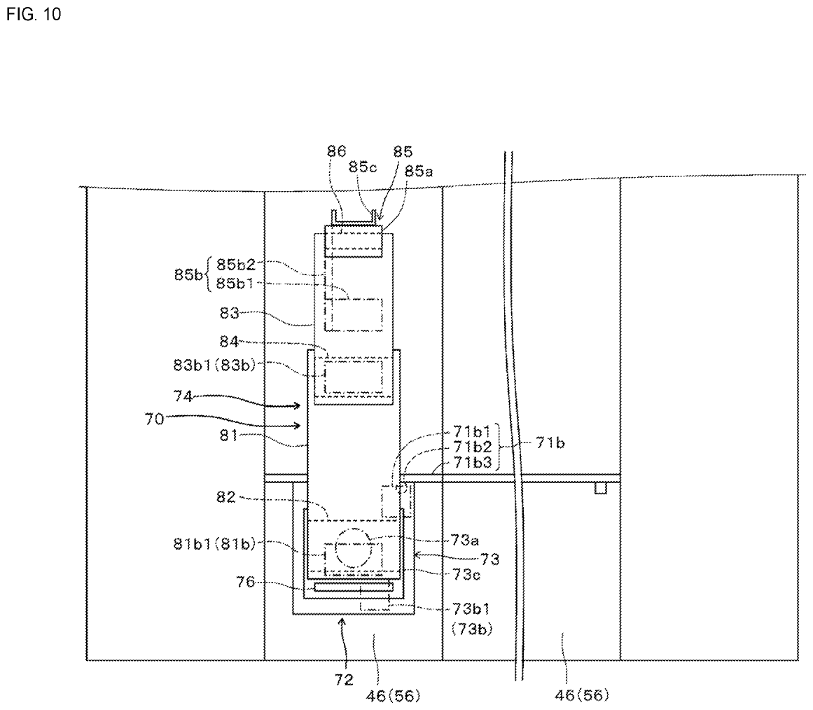

As shown in FIGS. 9 and 10, main body section 72 is primarily composed of swivel table (table) 73 and arm section 74 provided on swivel table 73.

Swivel Table

As shown in FIG. 10, swivel table 73 is provided with table drive axis 73a (hereinafter sometimes referred to as the D-axis) and table drive device 73b, which drives table drive axis 73a in a rotating motion. Table drive device 73b is provided on the traveling section main body 71a. Table drive device 73b consists of a gear (not shown) on table drive axis 73a, a pinion (not shown) that meshes with this gear, servomotor 73b1, and a driving force transmission mechanism (not shown) that transmits the output of servomotor 73b1 to the pinion.

Servomotor 73b1 is connected to control device 90 (see FIG. 11). Servomotor 73b1 is driven in a rotating motion by commands from control device 90, causing a pinion to rotate table drive axis 73a. This allows swivel table 73 to rotate around the rotation axis of table drive axis 73a. Servomotor 73b1 is equipped with current sensor 73b2, which detects the current flowing to servomotor 73b1 (see FIG. 11). Like servomotor 71b1, servomotor 73b1 is provided with position sensor 73b3, which detects the position of servomotor 73b1 (see FIG. 11). The detection results of current sensor 73b2 and position sensor 73b3 are transmitted to control device 90.

Inverting Device

As shown in FIG. 9, swivel table 73 is provided with inverting device 76, which inverts workpiece W. Inverting device 76 inverts workpiece W after it has been received from workpiece gripping section 85 (hereinafter sometimes referred to simply as gripping section), which is able to hold workpiece W in accordance with commands from control device 90, and passes the inverted workpiece W back to gripping section 85. As shown in FIG. 9, inverting device 76 is composed of attachment table 76a, rotating device 76b, gripping device 76c, and pair of gripping claws 76d and 76d.

Arm Section

Arm section 74 is a so-called serial link type arm, in which the drive axes (or arms) are arranged in series. As shown in FIGS. 9 and 10, arm section 74 is mainly composed of primary arm 81, primary arm drive axis 82 (hereinafter sometimes referred to as the A-axis), secondary arm 83, secondary arm drive axis 84 (hereinafter sometimes referred to as the B-axis), gripping section 85, and gripping section drive axis 86 (hereinafter sometimes referred to as the C-axis).

As shown mainly in FIGS. 9 and 10, primary arm 81 is rod-shaped and is connected to swivel table 73 via primary arm drive axis 82 in such a way that primary arm 81 can rotate. In more specific terms, primary arm drive axis 82 is supported by support member 73c, which is attached to the top of swivel table 73, in such a way that primary arm drive axis 82 can rotate. Primary arm drive axis 82 is secured to the base section of primary arm 81. Primary arm drive axis 82 is driven in a rotating motion by primary arm drive device 81b. Primary arm drive section 81b consists of modules such as servomotor 81b1, which is provided in support member 73c, and a driving force transmission mechanism (not shown) that transmits the output of servomotor 81b1 to primary arm drive axis 82.

Servomotor 81b1 is connected to control device 90 (see FIG. 11). Servomotor 81b1 is driven in a rotating motion by commands from control device 90, and rotates primary arm drive axis 82. This allows primary arm 81 to rotate around the rotation axis of primary arm drive axis 82. Servomotor 81b1 is equipped with current sensor 81b2, which detects the current flowing to servomotor 81b1 (see FIG. 11). Like servomotor 71b1, servomotor 81b1 is equipped with position sensor 81b3, which detects the position of servomotor 81b1 (see FIG. 11). The detection results of current sensor 81b2 and position sensor 81b3 are transmitted to control device 90.

As shown mainly in FIGS. 9 and 10, secondary arm 83 is rod-shaped and is connected to primary arm 81 via secondary arm drive axis 84 in such a way that secondary arm 83 can rotate. In more specific terms, secondary arm drive axis 84 is supported at the end of primary arm 81 in such a way that secondary arm drive axis 84 can rotate. Secondary arm drive axis 84 is secured to the base section of secondary arm 83. Secondary arm drive axis 84 is driven in a rotating motion by secondary arm drive device 83b. Secondary arm drive device 83b consists of modules such as servomotor 83b1, which is installed in primary arm 81, and a driving force transmission mechanism (not shown) that transmits the output of servomotor 83b1 to secondary arm drive axis 84.

Servomotor 83b1 is connected to control device 90. (See FIG. 11.) Servomotor 83b1 is driven in a rotating motion by commands from control device 90, and rotates secondary arm drive axis 84. This allows secondary arm 83 to rotate around the rotation axis of secondary arm drive axis 84. Servomotor 83b1 is equipped with current sensor 83b2, which detects the current flowing to servomotor 83b1 (see FIG. 11). Like servomotor 71b1, servomotor 83b1 is equipped with position sensor 83b3, which detects the position of servomotor 83b1 (see FIG. 11). The detection results of current sensor 83b2 and position sensor 83b3 are transmitted to control device 90.

As shown mainly in FIGS. 9 and 10, gripping section 85 is connected to secondary arm 83 via gripping section drive axis 86 in such a way that gripping section 85 can rotate. In more specific terms, gripping section drive axis 86 is supported on the end of secondary arm 83 in such a way that gripping section drive axis 86 can rotate. Gripping section main body 85a of gripping section 85 is secured to gripping section drive axis 86. Gripping section drive axis 86 is driven in a rotating motion by gripping section drive device 85b. Gripping section drive device 85b consists of modules such as servomotor 85b1, which is installed in secondary arm 83, and driving force transmission mechanism 85b2, which transmits the output of servomotor 85b1 to gripping section drive axis 86. Gripping section main body 85a can be attached to and detached from pair of chucks (robot chucks) 85c and 85c, which each grasp workpiece W. Pair of robot chucks 85c and 85c are provided on the front and rear surfaces of gripping section main body 85a. The rear surface is on the side opposite to the front surface.

Servomotor 85b1 is connected to control device 90 (see FIG. 11). Servomotor 85b1 is driven in a rotating motion by commands from control device 90, and rotates gripping section drive axis 86. This allows gripping section main body 85a to rotate around the rotation axis of gripping section drive axis 86. Servomotor 85b1 is equipped with current sensor 85b3, which detects the current flowing to servomotor 85b1 (see FIG. 11). Like servomotor 71b1, servomotor 85b1 is equipped with position sensor 85b4, which detects the position of servomotor 85b1. (See FIG. 11.) The detection results of current sensor 85b3 and position sensor 85b4 are transmitted to control device 90.

Robot Control Device

Control device 90 drives traveling drive unit 71b and thereby controls travel drive axis 71c, drives table drive device 73b and thereby controls table drive axis 73a, drives primary arm drive device 81b and thereby controls primary arm drive axis 82, drives secondary arm drive device 83b and thereby controls secondary arm drive axis 84, and drives gripping unit drive device 85b and thereby controls gripping unit drive axis 86. Control device 90 is a control device that controls base module 20.

As shown in FIG. 11, control device 90 is connected to input-output device 90a, storage device 90b, communication device 90c, workpiece detecting device 90d, inverting device 76, servomotors 71b1, 73b1, 81b1, 83b1, and 85b1, current sensors 71b4, 73b2, 81b2, 83b2, and 85b3, and position sensors 71b5, 73b3, 81b3, 83b3, and 85b4. Control device 90 has a microcomputer (not shown), which is provided with an input-output interface, CPU, RAM, and ROM (none of which are shown) that are connected to each other via a bus.

As shown in FIG. 1, input-output device 90a is provided on the front surface of work machine module 30, and functions in the same way as input-output device 47a. Like input-output device 47a, input-output device 90a can consist of input-output device 11, or it can have a configuration simpler than input-output device 11. Storage device 90b stores data related to control of robot 70, such as control programs, parameters used in control programs, and data related to settings and commands. Communication device 90c is a device similar to communication device 47c.

Workpiece detecting device 90d is a device that detects whether workpiece W is attached to inverting device 76. Workpiece detecting device 90d detects whether workpiece W is present and notifies control device 90 of the detection result. Workpiece detecting device 90d may consist of a pressure sensor (contact sensor) provided on gripping claw 76d, or an imaging device (such as a CCD camera) provided on traveling chambers 46 and 56.

Network

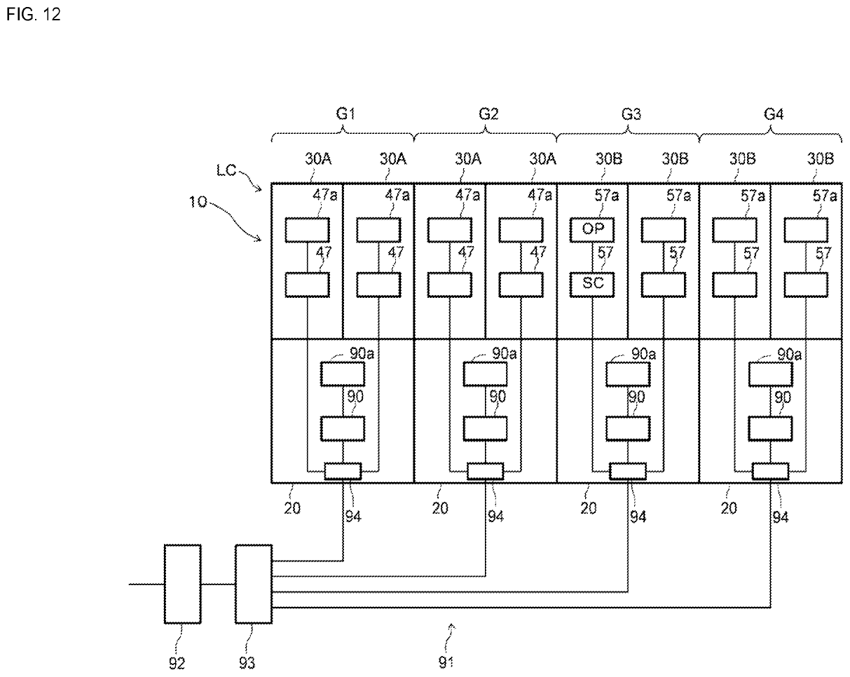

The following description of local area network 91 (hereinafter sometimes referred to as the network) for processing system 10 refers to FIG. 12. The processing system 10 shown in FIG. 12 consists of four base modules 20, four lathe modules 30A mounted on the left two base modules 20, and four drilling and milling modules 30B mounted on the right two base modules 20. Network 91 is a network consisting of multiple control devices 90 which control base modules 20, multiple control devices 47 which control lathe modules 30A, and multiple control devices 57 which control drilling and milling modules 30B. Each control device 90, control device 47, and control device 57 is able to communicate with the other control devices through network 91.

Network 91 is connected to the internet (not shown) via router 93 and modem 92. One HUB 94 is provided on each base module 20. Control devices 90 which control each of the modules mounted on a base module 20 are connected to router 93 via HUB 94.

For example, in the left two base modules 20, the control devices 90 that control the base modules 20, as well as the control devices 47 that control the two mounted lathe modules 30A, are connected to router 93 via HUB 94. Here, input-output device 90a is connected to control device 90, and input-output device 47a is connected to control device 47. In the right two base modules 20, the control devices 90 that control the base modules 20, as well as the control devices 57 of the two mounted drilling and milling modules 30B, are connected to router 93 via HUB 94. Here, input-output device 90a is connected to control device 90, and input-output device 57a is connected to control device 57.

Search and Other Operations

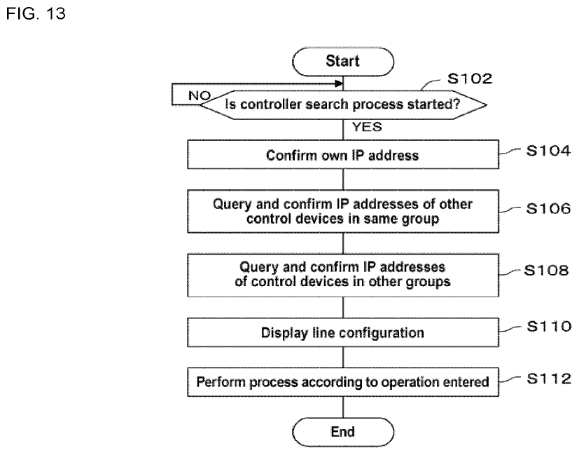

The following description of the search, display, and data management operations (operations such as searching) of line configuration LC of processing system 10 refers to the flowchart in FIG. 13. The control device that executes operations such as this search is whichever control device (origin control device) is connected and in communication with the input-output device (operation panel) being operated by an operator. For example, in a case in which an operator is currently operating input-output device 57a of the drilling and milling module 30B which is on the left side of the base module 20 which is 3rd from the left, as shown in FIG. 12, the control device that will perform searches and other operations is the control device directly connected to the operation panel currently in use (input-output device 57a). Control device 57 is an origin control device SC (hereinafter sometimes referred to as control device SC) that searches for the ID numbers of the other control devices that make up network 91.

A control device ID number can be an IP address (Internet Protocol address), for example, which is set (specified) for each control device in advance by an operator via manual operation after the installation of processing system 10. An IP address is a network layer ID number used to identify devices on a network by using Internet Protocol. A number other than an IP address can be used as the ID number of a control device, as long as the number can identify the control device in the network.

In this embodiment, the IP address is shown in IPv4 notation. In other words, the IP address is shown as four sets of numbers from 0-255 (8 bits×4=32 bits) connected by periods, for example, XXX.XXX.1.1. “X” represents a number. An IP address consists of a group ID number, which is the ID number of the group, and a module ID number, which is an ID number that indicates the location of the module within the group. In this IP address, the third number (from left to right) is the group ID number, which is a number indicating the group (composed of multiple modules), and the fourth number is the module ID number, which is a number indicating the position (location) of the module in the group. The location can be, for example, lower, upper left, or upper right.

The group ID number is a number that indicates the order of the groups, for example, in order from leftmost to rightmost. Alternatively, the order can be from the rightmost to the leftmost, or from one group in the middle to the right (lapping back to the leftmost group after the last group to the right and then continuing rightward until the group immediately before the origin group is reached), or from one group in the middle to the left (lapping back to the rightmost group after the last group to the left and then continuing leftward until the group immediately before the origin group is reached). The module ID number is a number that indicates the location. For example, 1 indicates the lower position, 2 indicates the upper left position, and 3 indicates the upper right position.

In the processing system 10 shown in FIG. 12, the groups are ordered from left to right, starting from Group 1 (G1) and ending with Group 4 (G4). Each group from G1 to G4 is made up of a single base module 20. Group 1 (G1) consists of the leftmost base module 20, the lathe module 30A mounted on the upper left of that base module 20, and the lathe module 30A mounted on the upper right of that base module 20. Group 2 (G2) consists of the second base module 20 from the left, the lathe module 30A mounted on the upper left of that base module 20, and the lathe module 30A mounted on the upper right of that base module 20. Group 3 (G3) consists of the third base module 20 from the left, the drilling and milling module 30B mounted on the upper left of that base module 20, and the drilling and milling module 30B mounted on the upper right of that base module 20. Group 4 (G4) consists of the fourth (rightmost) base module 20 from the left, the drilling and milling module 30B mounted on the upper left of that base module 20, and the drilling and milling module 30B mounted on the upper right of that base module 20.

The IP address of control device 90 of base module 20 in Group 1 (G1) is (XXX.XXX.1.1). The IP address of control device 47 of the lathe module 30A mounted at the upper left in Group 1 (G1) is (XXX.XXX.1.2). The IP address of control device 47 of the lathe module 30A mounted at the upper right in Group 1 (G1) is (XXX.XXX.1.3). The IP address of control device 90 of base module 20 in Group 2 (G2) is (XXX.XXX.2.1). The IP address of control device 47 of the lathe module 30A mounted at the upper left in Group 2 (G2) is (XXX.XXX.2.2). The IP address of control device 47 of the lathe module 30A mounted at the upper right in Group 2 (G2) is (XXX.XXX.2.3).

The IP address of control device 90 of base module 20 in Group 3 (G3) is (XXX.XXX.3.1). The IP address of control device 57 of the drilling and milling module 30B mounted at the upper left in Group 3 (G3) is (XXX.XXX.3.2). The IP address of control device 57 of the drilling and milling module 30B mounted at the upper right in Group 3 (G3) is (XXX.XXX.3.3). The IP address of control device 90 of base module 20 in Group 4 (G4) is (XXX.XXX.4.1). The IP address of control device 57 of the drilling and milling module 30B mounted at the upper left in Group 4 (G4) is (XXX.XXX.4.2). The IP address of control device 57 of the drilling and milling module 30B mounted at the upper right in Group 4 (G4) is (XXX.XXX.4.3). In the following description, the first and second series of numbers in the IP addresses may be omitted, and only the third and fourth series of numbers may be displayed in some cases. For example, (XXX.XXX.1.1) can be shortened to (1.1).

We now return to describing search and other operations. In Step S102 of the program, the control device SC determines whether a control device search run command has been issued. In more specific terms, when the operator first presses Control Device Search key 130 and then presses Run key 140, the control device SC judges that a control device search run command has been issued, and advances the program to Step S104 to determine line configuration LC of processing system 10. If the operator does not press Control Device Search key 130 or Run key 140, the control device SC determines that a control device search run command has not been issued, and repeats the processing in Step S102 of the program.

In Steps S104 to S108 of the program, the ID number of the control device SC is used as an origin to search for the ID numbers of the remaining control devices in network 91 to determine line configuration LC of processing system 10.

In more specific terms, in Step S104 of the program, the control device SC first confirms its own IP address. The control device SC does this by loading its own IP address from a connected storage device (57b in this embodiment). In this embodiment, the IP address of the control device SC itself is (3.2), since the operation panel being used at the time is input-output device 57a of the upper-left drilling and milling module 30B of Group 2 (G3), and the control device SC is the control device of the upper-left drilling and milling module 30B in Group 3 (G3). Thus, the control device SC confirms that its own IP address is (3.2). From this confirmed IP address, the control device SC can also confirm that its own location is the module at the upper left in Group 3 (G3).

Next, in Step S106 of the program, the control device SC confirms the configuration of other modules 20 and modules 30 in the group to which the control device SC belongs by searching in network 91 for any groups with the same group ID number as the control device SC itself (“3” in this embodiment), which it confirmed in Step S104 of the program. In other words, the control device SC queries other control devices in network 91 for their IP addresses. From among the IP addresses it receives in response, it finds other control devices having the same group ID number as itself, and recognizes them as control devices within its own group.

Since the group ID number of the control device SC is 3, it can recognize that the two control devices whose IP addresses are (3.1) and (3.3) are other control devices within the group to which the control device SC itself belongs. As a result, the control device SC can recognize that Group 3 (G3), the group to which it belongs, consists of one base module 20 and two drilling and milling modules 30B.

In Step S108 of the program, the control device SC uses the group ID number it confirmed as belonging to itself in Step S104 as an origin from which to search in network 91 for Group ID numbers, either in ascending or descending order. This enables the control device SC to confirm the configuration of modules 20 and modules 30 in groups to which it does not belong. In other words, the control device SC queries other control devices in network 91 for their IP addresses. From among the IP addresses it receives in response, it finds other control devices having a different group ID number from itself, and recognizes them as control devices within groups other than its own.

In this embodiment, the group ID number of the control device SC is 3, so the control device SC can recognize the configuration of groups to which it does not belong by searching for group ID numbers in ascending order, starting from 4. In this embodiment, since group ID numbers from 1 to 4 will be recognized, the control device SC can search for all group ID numbers that are not 3 in the following order: 4→1→2. This will allow the control device SC to recognize that the other groups in network 91 consist of Group 1 (G1), Group 2 (G2), and Group 4 (G4). The control device SC can also recognize the configuration of modules 20 and modules 30 in each other group by searching for module ID numbers in ascending order (e.g., 1→2→3) in other groups. As a result, the control device SC can recognize that Group 1 (G1) and Group 2 (G2) consist of one base module 20 and two lathe modules 30A located on the left and right, respectively, and that Group 4 (G4) consists of one base module 20 and two drilling and milling modules 30B located on the left and right.

As a result of the process, the control device SC can determine that the line configuration LC of processing system 10 connected with network 91 consists of Group 1 (G1) and Group 2 (G2), which are each made up of one base module 20 and two lathe modules 30A located on the left and right, respectively, and Group 3 (G3) and Group 4 (G4), which are each made up of one base module 20 and two drilling and milling modules 30B located on the left and right, respectively.

Next, in Step S110 of the program, the control device SC displays line configuration map 111, representing the line configuration LC determined in Step S108, in Data Management screen 100. (See FIG. 5.) Line configuration map 111 of this embodiment is made up of four group maps 112. In the first group map 112 from the left, the IP address (1.1) of control device 90 is displayed in address display section 113a1 in base map 113a. The IP address (1.2) of control device 47 is displayed in address display section 113b1 of left-hand work machine map 113b. The IP address (1.3) of control device 47 is shown in address display section 113b1 of right-hand work machine map 113b.

In the second group map 112 from the left, the IP address (2.1) of control device 90 is displayed in address display section 113a1 in base map 113a. The IP address (2.2) of control device 47 is displayed in address display section 113b1 of left-hand work machine map 113b. The IP address (2.3) of control device 47 is displayed in address display section 113b1 of right-hand work machine map 113b.

In the third group map 112 from the left, the IP address (3.1) of control device 90 is displayed in address display section 113a1 of base map 113a. The IP address (3.2) of control device 57 is displayed in address display section 113b1 of left-hand work machine map 113b. The IP address (3.3) of control device 57 is displayed in address display section 113b1 of right-hand work machine map 113b.

In the fourth group map 112 from the left, the IP address (4.1) of control device 90 is displayed in address display section 113a1 of base map 113a. The IP address (4.2) of control device 57 is displayed in address display section 113b1 of left-hand work machine map 113b. The IP address (4.3) of control device 57 is displayed in address display section 113b1 of right-hand work machine map 113b.

In Step S112 of the program, the control device SC executes processes based on operations the operator has executed. For example, if the operation an operator has performed executes a Copy operation, the control device SC will execute the Copy process. If the operation an operator has performed executes a Backup operation, the control device SC will execute the Backup process.

In a Copy operation, the operator presses Copy key 121c, specifies the source and destination of the data and the data to be moved, and then presses Run key 140. The Copy process copies the data to be moved from the source to the destination. In a Backup operation, the operator presses Backup key 122c, presses either Single key 122a or All key 122b, and then presses Run key 140. The Backup process saves module data to a backup device in such a way that it can be restored for each module individually or for all modules.

In the first embodiment, processing system 10 is a linear production device which consists of multiple modules 20 and modules 30 arranged in a linear formation, which process a workpiece W. Each module 20 and module 30 can be equipped with control devices 47, 57, or 90 that will control the module 20 or module 30 in question, and can be equipped with input-output devices (operation panels) 47a, 57a, or 90a which connect to control devices 47, 57, or 90 and can be used by operators to enter operations. Each control device 47, 57, and 90 has an IP address (ID number) assigned in advance and can also communicate with other control devices in network 91. A control device SC (origin control device) in communication with input-output units 47a, 57a, or 90a being operated by an operator will determine the line configuration of processing system 10 by searching for the IP addresses of remaining control devices 47, 57, and 90 in network 91, using the IP address of the control device SC itself as the origin.

In combination with the IP addresses assigned in advance to each of the control devices 47, 57, or 90 provided in the multiple modules 20 and modules 30 which make up processing system 10 (linear production device), this process enables communication between control devices through network 91. A control device SC (origin control device) selected from among all control devices 47, 57, and 90 and which is in communication with an operation panel currently in use by an operator can determine the line configuration of processing system 10 by searching for the IP addresses of remaining control devices in network 91, using the IP address of the control device SC itself as the origin. The control device SC can display the determined line configuration LC, and by referencing that line configuration LC, can display on the operation panel currently in use the operation keys 121c, 122c, 130, 140, and 150 for use in copying data stored in each module 20 or module 30. This allows data stored in multiple control devices 47, 57, or 90 in a network 91 to be easily managed from one of the control devices 47, 57, or 90 (control device SC).

In this processing system 10, line configuration LC consists of multiple groups of modules 20 and modules 30 that are arranged in a linear formation. The ID numbers (IP addresses) of control devices 47, 57, or 90 are composed of a group ID number, which is the ID number of the group, and a module ID number, which is the ID number indicating the location of the modules 20 and modules 30 within the group. The origin control device (control device SC) confirms its own group ID number and module ID number, and then confirms the configuration of modules 20 and modules 30 in the group to which it belongs by searching in network 91 for the same group ID number as its own confirmed group ID number. Then, using its own confirmed group ID number as the origin, the control device SC searches in network 91 for group ID numbers, in ascending or descending order, and thus confirms the configuration of modules 20 and modules 30 which belong to other groups than the control device SC itself. This enables the control device SC to determine line configuration LC of the linear production device (processing system 10). This enables the control device SC to easily check the configuration of the modules 20 and modules 30 that make up each group, and thus easily determine line configuration LC of processing system 10.

In this processing system 10, operation panels (input-output devices 47a, 57a, or 90a) are provided with Data Management screen 100 displaying line configuration map 111, indicating the determined line configuration LC, and operation keys 121c, 122c, 130, 140, 150 for use in copying data stored in each module 20 and module 30 referenced in line configuration map 111.

This enables the control device SC to display on the input-output devices 47a, 57a, or 90a the determined line configuration LC and operation keys 121c, 122c, 130, 140, and 150 for use in copying data stored in each module 20 and module 30 referenced in line configuration LC. This allows data stored in multiple control devices 47, 57, or 90 in a network 91 to be easily managed from one of the control devices 47, 57, or 90 (control device SC).

### Second Embodiment

The following describes a second embodiment, which is a processing system that uses the linear production device. In the first embodiment, the control device IP address (ID number) is manually assigned in advance by an operator. In the second embodiment, the control device IP address is assigned in advance automatically. In this embodiment, processing system 10 is provided with physical position determining device 10A for determining the physical position of each module 20 and module 30.

Physical position determining device 10A consists of robot 70 mounted on base module 20, workpiece detecting device 47d mounted on lathe module 30A, and workpiece detecting device 57d mounted on drilling and milling module 30B.

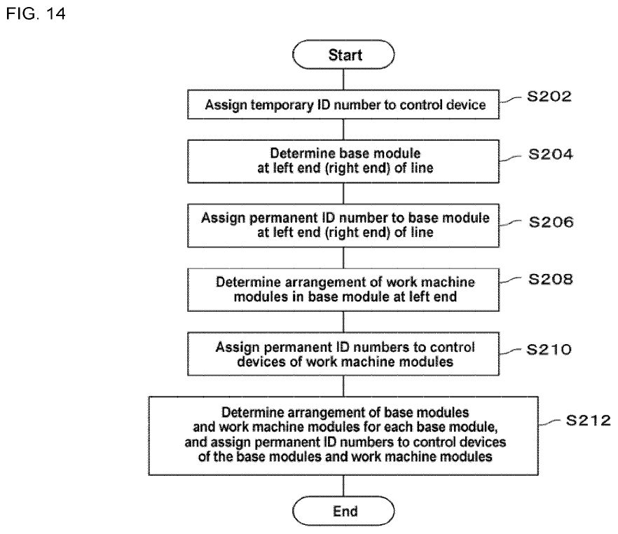

The flowchart in FIG. 14 describes automatic IP address assignment control (hereinafter sometimes referred to as automatic assignment control) in the processing system 10 disclosed in this second embodiment. The control device that executes the automatic assignment control is whichever control device SC is connected and in communication with the input-output device (operation panel) being operated by an operator.

In Step S202 of the program, the control device SC assigns a temporary IP address to each control devices 47, 57, and 90 in processing system 10. In Step S204 of the program, the control device SC determines which base module 20 is located on the left side of the processing system 10 module array. In more specific terms, the control device SC sends a command to all control devices 47, 57, and 90 (including the control device SC itself) which have been assigned temporary IP addresses to send a workpiece carry-in command. (This is a given control command issued to physical position determining device 10A). This command causes robot 70 to take workpiece W from pre-processing stock module 30C and mount it in inverting device 76.

Upon receiving the workpiece carry-in command, the control device 90 connected to robot 70 drives robot 70 to mount workpiece W on inverting device 76. Any control devices 47 or 57 which are not connected to robot 70 will not drive robots even if they receive the workpiece carry-in command. Therefore, control device 90 will receive an ON signal from workpiece detecting device 90d, indicating that workpiece W was mounted, only with respect to the base module 20 containing the inverting device 76 on which workpiece W was mounted. Control device 90 will receive an OFF signal from workpiece detecting device 90d, indicating that workpiece W has not been mounted, with respect to any base module 20 containing an inverting device 76 on which workpiece W has not been mounted. The signal transmitted (output) from workpiece detecting device 90d is the control result of the robot 70 (physical position determining device 10A) which executed the workpiece gripping command (which is a given control command issued to physical position determining device 10A). Using the relationship between control commands and control results enables determination of which base module 20 is located at the left end of the processing system 10 module array.

In other words, this relationship allows the control device SC to determine that the base module 20 containing the control device 90 which entered the ON signal received from workpiece detecting device 90d after the workpiece carry-in command was issued (which caused robot 70 to take workpiece W out of pre-processing stock module 30C and mount it on inverting device 76) is one and the same with the base module 20 located at the left end of the module array. In Step S206 of the program, the control device SC changes the temporary IP address of control device 90 of this leftmost base module 20 (base module 20 of Group 1 (G1)) to the permanent IP address (1.1), thereby assigning a permanent IP address to control device 90 of leftmost base module 20.

In Steps S208 and S210, the control device SC determines the arrangement of work machine modules 30 for each base module 20, and assigns permanent IP addresses to control devices 47 and 57 of the work machine modules 30. In more specific terms, the control device SC causes control device 90 of base module 20 of Group 1 (G1) to drive robot 70 to transfer workpiece W, which had been mounted on inverting device 76, on upper left work machine module 30 of base module 20 of Group 1 (G1). The control device SC also issues a command to all control devices 47 and 57 to which temporary IP addresses have been assigned to send a workpiece gripping command (which is a given control command issued to physical position determining device 10A) to grip workpiece W conveyed to the workpiece modules 30 in question.

The control device 90 connected to robot 70 receives the workpiece gripping command and drives robot 70 so that it conveys workpiece W to the work machine module 30 at the upper left. Because control devices 47 and 57 of the work machine module 30 to which workpiece W was conveyed are gripping workpiece W, they receive an ON signal indicating that workpiece W has been mounted from workpiece detecting device 47d (or 57d). The signal transmitted (output) from workpiece detecting device 90d is the control result of the robot 70 (physical position determining device 10A) which executed the workpiece gripping command (which is a given control command issued to physical position determining device 10A). Using the relationship between control commands and control results enables determination of which work machine module 30 is located at the upper left of base module 20 of Group 1 (G1). The control device SC then assigns the permanent IP address (1.2) to control device 47 of work machine module 30 located at the upper left of Group 1 (G1).

The control device SC can determine which work machine module 30 is located at the upper right of base module 20 of Group 1 (G1) in the same way it determines which work machine module 30 is located at the upper left of base module 20. The control device SC then assigns the permanent IP address (1.3) to control device 47 of work machine module 30 located at the upper right of Group 1 (G1).

In Step S212 of the program, the control device SC determines the position of base modules 20 and work machine modules 30 in each base module 20, in order from left to right in the module array, and assigns permanent IP addresses to the control devices 90 of base modules 20 and control devices 47 and 57 of work machine modules 30 it finds.

First, the control device SC determines the base module 20 that is located right next to the base module 20 that has been given the permanent IP address. In more specific terms, the control device SC sends a command to all control devices 47, 57, and 90 (including the control device SC itself) which have been assigned temporary IP addresses to send a workpiece carry-in command (which is a given control command issued to physical position determining device 10A); this command causes robot 70 to take workpiece W from the base module 20 located at the immediate left and mount it in inverting device 76.

Upon receiving the workpiece carry-in command, the control device 90 connected to robot 70 drives robot 70 to take workpiece W from the base module located at the immediate left and mount it on inverting device 76. Any control devices 47 or 57 which are not connected to robot 70 will not drive robots even if they receive the workpiece carry-in command. Therefore, control device 90 will receive an ON signal from workpiece detecting device 90d, indicating that workpiece W was mounted, only with respect to the base module 20 containing the inverting device 76 on which workpiece W was mounted. Control device 90 will receive an OFF signal from workpiece detecting device 90d, indicating that workpiece W has not been mounted, with respect to any base module 20 containing an inverting device 76 on which workpiece W has not been mounted. The signal transmitted (output) from workpiece detecting device 90d is the control result of the robot 70 that executed the workpiece carry-in command. Using the relationship between control commands and control results enables determination of which base module 20 is located to the immediate right of the base module to which the permanent IP address has been assigned. Next, the control device SC changes the temporary IP address of control device 90 of the base module 20 located to the immediate right (which is base module 20 of Group 2 (G2)) to a permanent IP address (2.1), thereby assigning a permanent IP address to control device 90 of the base module 20 located at the immediate right.

Like it determined which work machine modules 30 are located at the upper left and right of base module 20 of Group 1 (G1), the control device SC then determines which work machine modules 30 are located at the upper left and right of base module 20 of Group 2 (G2). Next, the control device SC assigns permanent IP address (2.2) to control device 47 of work machine module 30 located at the upper left of Group 2 (G2), and assigns permanent IP address (2.3) to control device 47 of work machine module 30 located at the upper right of Group 2 (G2).

Like it did with Group 2 (G2), the control device SC then determines the locations of base modules 20 and work machine modules 30 in Group 3 (G3) and Group 4 (G4), and assigns permanent IP addresses to the control devices 90 of base modules 20 and control devices 47 and 57 of work machine modules 30 that it finds.

In the second embodiment, since IP addresses can be automatically assigned to control devices in advance, data stored in multiple control devices 47, 57, and 90 in a network 91 can be more easily managed from one of the control devices 47, 57, or 90 (control device SC).

In the second embodiment, IP addresses can be assigned to control devices 47, 57, and 90 in advance by first assigning temporary IP addresses to the control devices 47, 57, and 90, and then using these temporary IP addresses to assign permanent IP addresses.

This enables automatic pre-assignment of (permanent) IP addresses to multiple control devices 47, 57, and 90 on a network 91. Data stored in multiple control devices 47, 57, and 90 in a network 91 can thus be more easily managed from one of the control devices 47, 57, or 90 (control device SC).

In the second embodiment, processing system 10 is equipped with physical position determining device 10A for determining the physical position of each module 20 and 30. Control devices 47, 57, and 90 of each module 20 and 30 determine the physical position of each module 20 and 30 based on certain control commands issued to physical position determining device 10A, and also based on the control results from the physical position determining device 10A that executed the control commands. The physical positions thus found are used to change temporarily assigned IP addresses to permanent IP addresses.

This enables a relatively simple configuration to automatically assign (permanent) IP addresses to multiple control devices 47, 57, and 90 in a network 91. This also allows data stored in multiple control devices 47, 57, or 90 in a network 91 to be easily managed from one of the control devices 47, 57, or 90 (control device SC).

### Third Embodiment

The following describes the third embodiment, which is a processing system that uses the linear production device. In the second embodiment, the same configuration as in the first embodiment was used to control the automatic pre-assignment of IP addresses to control devices. In the third embodiment, a dedicated physical location detecting device 10B is added to the configuration of the first embodiment, and controls the automatic pre-assignment of IP addresses to control devices.

Physical position detecting device 10B is a device (physical position determining device) for determining the physical position of each module 20 and module 30. As shown in FIG. 15, physical position detecting device 10B consists of first position detecting device S1 for detecting the left-right position relationship of base modules 20, and second position detecting device S2 for detecting the positional relationship of work machine modules 30 with respect to base modules 20.

First position detecting device S1 consists of light-emitting section S1t, which sends light (for example, infrared radiation), and light receiving section S1r, which receives light from light-emitting section S1t. Light-emitting section S1t can include such elements as light-emitting diodes; light-receiving section S1r can include such elements as photo transistors.

First position detecting device S1 is provided on base module 20, with light-emitting section S1t provided on the right side of base module 20 and light-receiving section S1r provided on the right side of base module 20. Light-emitting section S1t may also be positioned on the left side and light-receiving section S1r on the right side. Light-emitting section S1t (or light-receiving section S1r) faces the light-receiving section S1r (or light-emitting section S1t) on the neighboring base module 20. Light-receiving sections S1r on a base module 20 which is the last module on the left, as well as light-emitting sections S1t on a base module 20 which is the last module on the right, are not provided with a corresponding light-emitting section S1t or light-receiving section S1r (these sections do not exist).

Light-emitting section S1t is connected to control device 90, and emits light in accordance with commands from control device 90. Light-receiving section S1r is connected to control device 90, and transmits an ON signal indicating that light was received to control device 90 when light is received. It transmits an OFF signal indicating that light was not received to control device 90 when light is not received.

Second position detection device S2 consists of light-emitting section S2t, which emits light in the same way as light-emitting section S1t, and light-receiving section S2r, which receives light from light-emitting section S2t in the same way as light-receiving section S1r. Light-emitting section S2t of second position detecting device S2 is provided on the lower surface of work machine modules 30, and two light-receiving sections S2r of second position detecting device S2 are provided on the upper surface of base modules 20. Of the two light-receiving sections S2r, the one at the upper left of base module 20 is S2r1; light-receiving section S2r1 faces light-emitting section S2t on the bottom of work machine modules 30 mounted at the upper left of base modules 20. Of the two light-receiving sections S2r, the one at the upper right of base module 20 is S2r2; light-receiving section S2r2 faces light-emitting section S2t on the bottom of work machine modules 30 mounted at the upper right of base modules 20.

Light-emitting sections S2t are connected to control devices 47 or 57, and emit light based on commands issued from control devices 47 or 57. Light-receiving section S2r is connected to control device 90, and transmits an ON signal indicating that light was received to control device 90 when light is received. It transmits an OFF signal indicating that light was not received to control device 90 when light is not received.

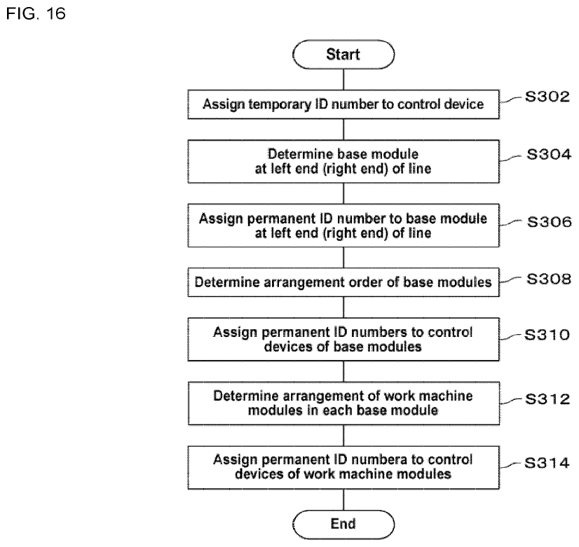

The flowchart in FIG. 16 describes automatic IP address assignment control (hereinafter sometimes referred to as automatic assignment control) in the processing system 10 disclosed in the third embodiment. The control device that executes the automatic assignment control is whichever control device SC is connected and in communication with the input-output device (operation panel) being operated by an operator.

In Step S302 of the program, the control device SC assigns a temporary IP address to each control device 47, 57, and 90 in processing system 10. In Step S304 of the program, the control device SC determines which base module 20 is located on the left (or right) side of the processing system 10 module array. In more specific terms, the control device SC sends a command to all control devices 47, 57, and 90 (including the control device SC) to which temporary IP addresses have been assigned to emit light to light-emitting section S1t (which is a given control command issued to physical position detecting device 10B).

The control device 90 connected to light-emitting section S1t receives the light-emitting command and causes light-emitting section S1t to emit light. Any control devices 47 and 57 not connected to light-emitting section S1t do not cause light-emitting section S2t (which is not the same as light-emitting section S1t) to emit light. Therefore, only the light-receiving section S1r facing light-emitting section S1t receives light and transmits an ON signal indicating that light was received to the control device 90 connected to light-receiving section S1r. When light-emitting section S1t is lit, light-receiving sections S1r and 52r, which do not face light-emitting section S1t, do not receive light, and transmit an OFF signal indicating that light was not received to the control device 90 connected to light-receiving section S1r, and also transmit an OFF signal indicating that light was not received to the control devices 47 and 57 connected to light-receiving section S2R. The signal transmitted (output) from light-receiving sections S1r and S2r is the control result of the light-emitting section S1t (physical position detecting device 10B) which executed the light-emitting command (which is a given control command issued to physical position detecting device 10B). Using the relationship between control commands and control results enables determination of which base module 20 is located at the left (or right) end of the processing system 10 module array.

In other words, the light-receiving section S1r of a base module 20 transmits an ON signal to the base module 20 located at its immediate right, but the light-receiving section S1r of a base module not located at its immediate right transmits an OFF signal. This enables the control device SC to determine that the base module 20 with a control device 90 that transmitted an OFF signal is the base module 20 located at the left end of the module array. In Step S306 of the program, the control device SC changes the temporary IP address of the control device 90 of this leftmost base module 20 (base module 20 of Group 1 (G1)) to the permanent IP address (1.1), thereby giving a permanent IP address to control device 90 of leftmost base module 20.

In Step S308 of the program, the control device SC determines the order in which base modules 20 are arranged. In more specific terms, by using the relationship between control instructions and control results, the control device SC emits light from light-emitting section S1t of base module 20 of Group 1 (G1) and determines that the base module 20 with the light-receiving section Sir that received the emitted light is base module 20 of Group 2 (G2). The control device SC changes the temporary IP address of control device 90 of base module 20 in Group 2 (G2) to permanent IP address (2.1) (in Step S310). Like base modules 20 in Group 2 (G2), the control device SC assigns permanent IP addresses (3.1) and (4.1) to control devices 90 of base modules 20 of Group 3 (G2) and Group 4 (G4) (in Steps S308 and 310).

In Steps S312 and S314, the control device SC determines the arrangement of work machine modules 30 for each base module 20, and assigns permanent IP addresses to control devices 47 and 57 of the work machine modules 30. In more specific terms, by using the relationship between control commands and control results, the control device SC causes light-emitting sections S2t of work machine modules 30 to light, one after another. If light-receiving section S2r1, which is located at the upper left of base module 20 in Group 1 (G1), transmits an ON signal, the control device SC determines that the work machine module 30 with the light-emitting section S2t that it caused to light is the work machine module 30 located at the upper left in Group 1 (G1). The control device SC then causes light-emitting sections S2t of work machine module 30 to light, one after another. If light-receiving section S2r2, which is located at the upper right of base module 20 in Group 1 (G1), transmits an ON signal, the control device SC determines that the work machine module 30 with the light-emitting section S2t that it caused to light is the work machine module 30 located at the upper right in Group 1 (G1) (in Step S312). The control device SC assigns permanent IP address (1.2) to control device 47 of work machine module 30 located at the upper left in Group 1 (G1), and assigns permanent IP address (1.3) to control device 47 of work machine modules 30 located at the upper right of Group 1 (G1). Like Group 1 (G1), the control device SC assigns permanent IP addresses to control devices 47 and 57 of work machine modules 30 in groups from Group 2 (G2) to Group 4 (G4).

In the third embodiment, since IP addresses can be automatically assigned to control devices in advance, data stored in multiple control devices 47, 57, and 90 in a network 91 can be more easily managed from one of the control devices 47, 57, or 90 (control device SC).

In the third embodiment, IP addresses can be assigned to control devices 47, 57, and 90 in advance by first assigning temporary IP addresses to the control devices 47, 57, and 90, and then using these temporary IP addresses to assign permanent IP addresses. This achieves the same effect as in the second embodiment.

In the third embodiment, processing system 10 is equipped with physical position determining device 10B for determining the physical position of each module 20 and 30. Control devices 47, 57, and 90 of each module 20 and 30 determine the physical position of each module 20 and 30 based on certain control commands issued to physical position determining device 10B, and also based on the control results from the physical position determining device 10B that executed the control commands. The physical positions thus found are used to change temporarily assigned IP addresses to permanent IP addresses. This achieves the same effect as in the second embodiment.

In the third embodiment, physical position detecting device 10B is composed of a light-emitting section and a light-receiving section. However, it may be composed of other elements as long as it is a device for determining the physical position of each module 20 and 30 composed of a device which receives and is controlled by a given control command from a connected control device, along with a device which transmits the control result from the device which executed the control command to a connected control device, such as a pressure-applying section and pressure-receiving section.

### REFERENCE SIGNS LIST

10: processing system (linear production device); 20, 30: modules; 47, 57, 90: control devices; 47a, 57a, 90a: input-output devices (operation panels); 91: network; LC: line configuration; OP: operation panel; SC: control device (origin control device); W: workpiece

1. A linear production device that mechanically processes workpieces, the linear production device comprising: multiple modules arranged in a linear formation, wherein
each of the modules is equipped with a control device to control the module and an operation panel that is connected to the control device to enable a worker to enter operations,
each of the control devices has a preassigned ID number and is configured to communicate with the other control devices through a network, and
an origin control device, which is the control device connected in a manner allowing communication to the operation panel that is currently being used by the operator, uses the ID number of the origin control device so as to use the origin control device as an origin to control device search for the ID numbers of the remaining control devices in the network to determine a line configuration of the linear production device.

2. The linear production device according to claim 1, wherein
the linear formation consists of multiple groups, made up of multiple modules, formed into a line,
the ID number of the control device includes a group ID number, which is an ID number of the group, and a module ID number, which is an ID number indicating a position of the module within the group, and
the line configuration of the linear production device is determined by the origin control device confirming the group ID number and the module ID number of the origin control device, then confirming the configuration of modules within the group to which the origin control device belongs by searching in the network for the same group ID number as the confirmed group ID number of the origin control device, and then confirming the configuration of the modules in groups to which the origin control device does not belong by searching in the network for other group ID numbers, in ascending or descending order, starting from the confirmed group ID number of the origin control device.

3. The linear production device according to claim 1, wherein
the operation panel is provided with a data management screen configured to display a line configuration map indicating the determined line configuration and operation keys configured to be used to copy data stored in each module by referencing the displayed line configuration map.

4. The linear production device according to claim 1, wherein
a temporary ID number is assigned to the control device, then the temporary ID number is used to assign a permanent ID number, thereby enabling the ID number of the control device to be assigned in advance.

5. The linear production device according to claim 4, further comprising:
a physical position determining device configured to determine a physical position of each of the modules,
wherein the control device of each of the modules determines the physical position of each of the modules using a given control command issued to the physical position determining device and a control result of the physical position determining device that executed the control command, and
a result of this determination is used to change the previously-assigned temporary ID numbers to the permanent ID numbers.
